(19) United States
(12) Patent Application Publication
(10) Pub. No.: US 2013/0136217 A1
(43) Pub. Date: May 30, 2013

(54) LOW JITTER 2-STAGE INTERFACE RECEIVER FOR LOW POWER APPLICATION

(71) Applicant: Samsung Electro-Mechanics Co., Ltd., Gyeonggi-do (KR)

(72) Inventor: Eung Ju Kim, Seoul (KR)

(73) Assignee: SAMSUNG ELECTRO-MECHANICS CO., LTD., Gyeonggi-do (KR)

(21) Appl. No.: 13/689,127

(22) Filed: Nov. 29, 2012

(30) Foreign Application Priority Data
Nov. 30, 2011 (KR) 10-2011-0126982

(51) Int. Cl. H04B 1/10

(52) U.S. Cl. CPC H04B 1/10
USPC 375/346

(57) ABSTRACT

Disclosed herein is an interface receiver including: an input terminal receiving first and second data signals; a negative feedback unit negatively feeding back the first and second data signals input to the input terminal to generate first and second feedback signals; and an output terminal outputting logic level signals by using the first and second feedback signals generated by the negative feedback unit, whereby a timing margin can be secured.

### CROSS REFERENCE(S) TO RELATED APPLICATIONS

This application claims the benefit under 35 U.S.C. Section 119 of Korean Patent Application Serial No. 10-2011-012 6982, entitled “Interface Receiver” filed on Nov. 30, 2011, which is hereby incorporated by reference in its entirety into this application.

### BACKGROUND OF THE INVENTION

1. Technical Field

The present invention relates to an interface receiver transmitting a data signal by using a low voltage differential signaling (LVDS) scheme and, more particularly, to an interface receiver having a simplified internal structure to secure a timing margin by applying negative feedback.

2. Description of the Related Art

In general, as mobile devices such as mobile phones, or the like, have been upgraded and sophisticated, various functions are mounted to operate in mobile devices. In particular, in line with the trend of quality enhancement and high functionality, various multimedia functions including an MP3 player, a digital camera, and the like, are mounted in mobile devices, and in order to multimedia data, beyond a simple text transmission, displays such as a liquid crystal display (LCD), an organic light emitting diode (OLED), and the like, increasingly have high resolution.

However, a significantly high transfer rate is required for transmitting data between a central control device and devices that mounted multimedia functions and have high resolution displays.

As a solution to the transmission of high speed data, an interface using a low voltage differential signaling (LVDS) scheme has become noticed. Here, the hVDS scheme is a communication scheme which is resistant to noise in comparison to an existing scheme of using single end signaling and allows for a high speed transmission and reception of Gbps or higher. Since the LVDS scheme uses a low voltage, electromagnetic interference (EMI) is reduced, and since the LVDS scheme consumes less power, it can be applicable to various fields such as a data transmission between boards, as well as a data transmission between chips, and the like.

FIG. 1 is a view showing the configuration of an interface receiver according to a related art.

With reference to FIG. 1, the related art receiver 10 of interface, including an input terminal 13, a control terminal 15, and an output terminal 17, may convert applied first and second input signals Vp and Vm into signals fitting an LVDS scheme, and output the converted signals, thus processing a data transmission.

However, since the related art interface receiver includes three terminals, an operational bandwidth is limited due to capacitance of the elements constituting the respective terminals, retarding the overall processing rate.

Also, the interface receiver having the three-terminal structure is not easily driven by low power, and power noise applied to the input terminal affects jitter characteristics.

Thus, a timing margin of the interface receiver is reduced.

Therefore, in the art, an interface receiver having a simple internal structure with an increased operational bandwidth, driven by low power, and a timing margin by improving jitter characteristics is required.

### SUMMARY OF THE INVENTION

An object of the present invention is to provide an interface receiver having an increased operational bandwidth and configured with low power by using a two-terminal structure, instead of the three-terminal structure used in the related art.

Another object of the present invention is to provide an interface receiver having a timing margin by improving jitter characteristics by using a negative feedback unit.

According to an exemplary embodiment of the present invention, there is provided an interface receiver including: an input terminal receiving first and second data signals; a negative feedback unit negatively feeding back the first and second data signals input to the input terminal to generate first and second feedback signals; and an output terminal outputting logic level signals by using the first and second feedback signals generated by the negative feedback unit.

The negative feedback unit may have a regulated cascode structure.

The first and second data signals may include first and second differential signals having mutually opposite polarities.

The input terminal may have a rail-to-rail structure.

The input terminal may include a first transistor M1 having one terminal connected to a power source voltage VDD and a gate to which a first bias voltage biasp is applied; a second transistor M2 having one terminal connected to a first node A and a gate to which a first differential signal is applied; a third transistor M3 having one terminal connected to the other terminal of the first transistor M1 and a gate to which the first differential signal is applied; a fourth transistor M4 having one terminal connected to the other terminal of the first transistor M1 and a gate to which the first differential signal is applied; a fifth transistor MS having one terminal connected to a second mode B and a gate to which the first differential signal is applied; sixth and seventh transistors M6 and M7 each having one terminal connected to the other terminals of the second and fifth transistors M2 and M5, a gate to which a second bias voltage basin is commonly applied, and the other terminal connected to a ground voltage; an eighth transistor M8 having one terminal connected to the second node B and the other terminal connected to the ground voltage; a ninth transistor M9 having one terminal commonly connected to a gate thereof, the other terminal of the third transistor M3, and a gate of the eighth transistor M8, and the other terminal connected to the ground voltage; a tenth transistor M10 having one terminal commonly connected to a gate thereof and the other terminal of the fourth transistor M4, and the other terminal connected to the ground voltage; and an eleventh transistor Mil having one terminal connected to the first node A, a gate connected to the gate of the tenth transistor M10, and the other terminal connected to the ground voltage.

The negative feedback unit may include a first negative feedback unit negatively feeding back the first data signal to generate the first feedback signal, and outputting the first feedback signal; and a second negative feedback unit negatively feeding back the second data signal to generate the second feedback signal, and outputting the second feedback signal.

The first negative feedback unit may Include a twelfth transistor M12 having one terminal connected to the power source voltage and the other terminal connected to the first node A; a thirteenth transistor M13 having one terminal connected to the power source voltage: and the other terminal commonly connected to a gate thereof and a gate of the twelfth transistor M12; and a fourteenth transistor M14 having one terminal connected to the other terminal of the thirteenth transistor M13, a gate connected to the other terminal of the twelfth transistor M12, and the other terminal connected to one terminal of the seventh transistor M1.

The second negative feedback unit may include: a fifteenth transistor M15 having one terminal connected to the power source voltage and the other terminal connected to the second node B; a sixteenth transistor M16 having one terminal connected to the power source voltage and the other terminal commonly connected to a gate thereof and a gate of the fifteenth transistor M15; and a seventeenth transistor M17 having one terminal connected to the other terminal of the sixteenth transistor M16, a gate connected to one terminal of the eighth transistor M8, and the other terminal connected to one terminal of the seventh transistor M7.

The output terminal may include: an eighteenth transistor M18 having one terminal connected to the power source voltage and a gate to which the first bias voltage biasp is applied; a nineteenth transistor M19 having one terminal connected to the other terminal of the eighteenth transistor M18 and a gate connected to one terminal of the eleventh transistor M11; a twentieth transistor M20 having one terminal connected to the other terminal of the eighteenth transistor M18 and a gate connected to the gate of the seventeenth transistor M17; a twenty-first transistor M21 having one terminal commonly connected to a gate thereof and the other terminal connected to the ground voltage; a twenty-second transistor M22 having one terminal connected the other terminal of the twentieth transistor M20, a gate commonly connected to the twenty-first transistor M21, and the other terminal connected to the ground voltage; a twenty-third transistor M23 having one terminal connected to the power source voltage and a gate connected to a common contact of the other terminal of the twentieth transistor M20 and one terminal of the twenty-second transistor M22; and a twenty-fourth transistor M24 having one terminal connected to the other terminal of the twenty-third transistor M23, a gate commonly connected to the gate of the twenty-third transistor M23, and the other terminal connected to the ground voltage.

The output terminal may output the logic level signals from a common contact of the other terminal of the twenty-third transistor and one terminal of the twenty-fourth transistor.

According to another exemplary embodiment of the present invention, there is provided an interface receiver including: an input terminal receiving first and second data signals; a first negative feedback unit including a twelfth transistor M12 in which a first current flows according to the first data signal, a thirteenth transistor M13 mirroring the current flowing through the twelfth transistor M12, and a fourteenth transistor M14 connected in series to the thirteenth transistor M13, and negatively feeding back the first data signal to generate a first feedback signal; a second negative feedback unit including a fifteenth transistor M15 in which a second current flows according to the second data signal, a sixteenth transistor M16 mirroring the current flowing through the fifteenth transistor M15, and a seventeenth transistor M17 connected in series to the sixteenth transistor M16, and negatively feeding back the second data signal to generate a second feedback signal; and an output terminal outputting logic level signals by using the first and second feedback signals generated by the first and second negative feedback units, respectively.

The input terminal may include: a first transistor M1 having one terminal connected to a power source voltage VDD and a gate to which a first bias voltage biasp is applied; a second transistor M2 having one terminal connected to a first node A and a gate to which a first data signal is applied; a third transistor M3 having one terminal connected to the other terminal of the first transistor M1 and a gate to which the first differential signal is applied; a fourth transistor M4 having one terminal connected to the other terminal of the first transistor M1 and a gate to which the first differential signal is applied; a fifth transistor M5 having one terminal connected to a second node B and a gate to which the first data signal is applied; sixth and seventh transistors M6 and M7 each having one terminal connected to the other terminals of the second and fifth transistors M2 and M5, a gate to which a second bias voltage biasn is commonly applied, and the other terminal connected to a ground voltage; an eighth transistor M8 having one terminal connected to the second node B and the other terminal connected to the ground voltage; a ninth transistor M9 having one terminal commonly connected to a gate thereof, the other terminal of the third transistor M3, and a gate of the eighth transistor M8, and the other terminal connected to the ground voltage; a tenth transistor M10 having one terminal commonly connected to a gate thereof and the other terminal of the fourth transistor M4, and the other terminal connected to the ground voltage; and an eleventh transistor Mil having one terminal connected to the first node A, a gate connected to the gate of the tenth transistor M10, and the other terminal connected to the ground voltage.

The twelfth transistor M12 may have one terminal connected to the power source voltage and the other terminal connected to the first node A, the thirteenth transistor M13 may have one terminal connected to the power source voltage and the other terminal commonly connected to a gate thereof and a gate of the twelfth transistor M12; and the fourteenth transistor M14 may have one terminal connected to the other terminal of the thirteenth transistor M13, a gate connected to the other terminal of the twelfth transistor M12, and the other terminal connected to one terminal of the seventh transistor M7.

The fifteenth transistor M1 5 may have one terminal connected to the power source voltage and the other terminal connected to the second node B, the sixteenth transistor M1 6 may have one terminal connected to the power source voltage and the other terminal commonly connected to a gate thereof and a gate of the fifteenth transistor M15, and the seventeenth transistor M17 may have one terminal connected to the other terminal of the sixteenth transistor M16, a gate connected to one terminal of the eighth transistor M8, and the other terminal connected to one terminal of the seventh transistor M7.

The output terminal may include: an eighteenth transistor M18 having one terminal connected to the power source voltage and a gate to which the first bias voltage biasp is applied; a nineteenth transistor M19 having one terminal connected to the other terminal of the eighteenth transistor M18 and a gate connected to one terminal of the eleventh transistor M11; a twentieth transistor M20 having one terminal connected to the other terminal of the eighteenth transistor M18 and a gate connected to the gate of the seventeenth transistor M17; a twenty-first transistor M21 having one terminal commonly connected to a gate thereof and the other terminal connected to the ground voltage; a twenty-second transistor M22 having one terminal connected the other terminal of the twentieth transistor M20, a gate commonly connected to the twenty-first transistor M21, and the other terminal connected to the ground voltage; a twenty-third transistor M23 having one terminal connected to the power source voltage and a gate connected to a common contact of the other terminal of the twentieth transistor M20 and one terminal of the twenty-second transistor M22; and a twenty-fourth transistor M24 having one terminal connected to the other terminal of the twenty-third transistor M23, a gate commonly connected to the gate of the twenty-third transistor M23, and the other terminal connected to the ground voltage

### BRIEF DESCRIPTION OF THE DRAWINGS

FIG. 1 is a view showing the configuration of an interface

FIG. 2 is a schematic view showing the configuration of an interface receiver according to an exemplary embodiment of the present invention;

FIG. 3 is a view showing an internal configuration of a data reception unit illustrated in FIG. 2;

FIG. 4 is an internal detailed circuit diagram of the data reception unit illustrated in FIG. 2;

FIG. 5A is a graph showing a data eye structure and jitter characteristics according to the related art when noise is applied to a power source voltage and a ground voltage;

FIG. 5B is a graph showing a data eye structure and jitter characteristics according to an exemplary embodiment of the present invention when noise is applied to a power source voltage and a ground voltage; and

FIG. 6 is a graph showing a comparison between an operational bandwidth of the interface receiver according to an exemplary embodiment of the present Invention and that of the related art.

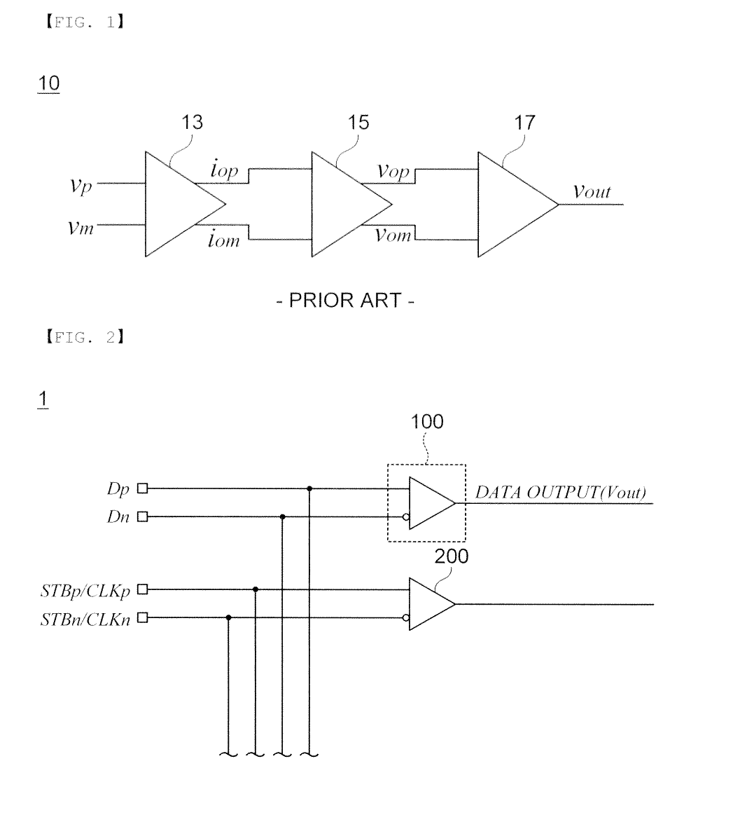

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

The embodiments of the present invention will now be described in detail with reference to accompanying drawings below.

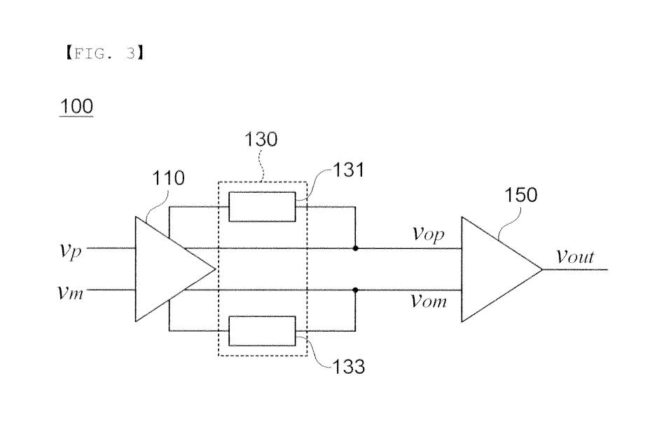

FIG. 2 is a schematic view showing the configuration of an interface receiver according to an exemplary embodiment of the present invention.

First, as shown in FIG. 2, a receiver 1 of interface includes a data reception unit 100 receiving first and second data signals and a control signal reception unit 200 receiving first and second strobe/clock signals.

The data reception unit 100 includes parallel input terminals such as a positive input pin DP and a negative input pin DN and receives first and second data signals from the positive input pin DP and the negative input pin DM, respectively.

The data reception unit 100 transmits a data signal by using a low voltage differential signaling (LVDS) scheme, and in this case, a mobile display digital interface (MDDI) scheme and a mobile industry processor interface (MIPI) scheme may be globally used at about 1 Gbps. Namely, the MDDI scheme is used in a typical LVDS area, and the MIPI scheme may swing, for example, from 100 mV to 170 mV to detect a data signal of 100 mV or higher from 0 up to a power source voltage VDD.

The control signal reception unit 200 has the same structure as that of the data reception unit 100 and operates in the same manner. Namely, the control signal reception unit 200 receives first and second strobe/clock signals through a positive strobe/clock pin (STB_{P}/CLK_{P}) and a negative strobe/clock pin (STB_{N}/CLK_{N}).

Internal components of the data reception unit 100 of the interface receiver according to an exemplary embodiment of the present invention will be described in detail.

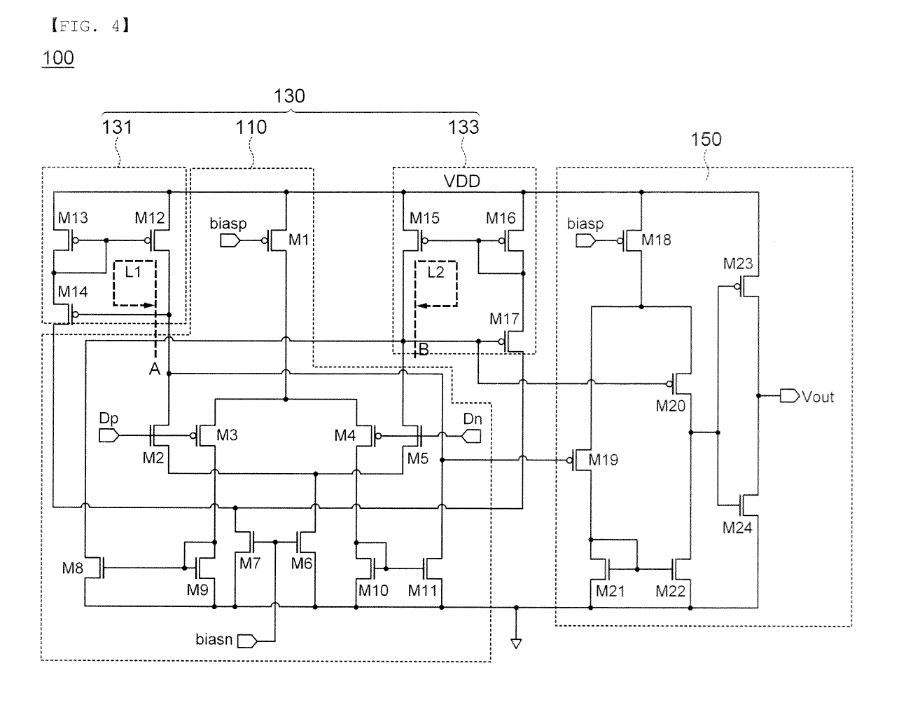

FIG. 3 is a view showing an internal configuration of the data reception unit illustrated in FIG. 2, and FIG. 4 is an internal detailed circuit diagram of the data reception unit illustrated in FIG. 2.

As shown in FIG. 3, the data reception unit 100 may include an input terminal 110, a negative feedback unit 130, and an output terminal 150.

The input terminal 110 receives first and second data signals Vp and Vm through the positive input pi n DP and the negative input pin DN, respectively.

The input terminal 110 has a rail-to-rail structure and receives the first and second data signals corresponding to a certain input signal range. Namely, the input terminal 110 is configured to receive the first and second data signals including both a data signal based on the MDDI scheme and a data signal based on the MIPI scheme.

Here, the first and second data signals may be configured as first and second differential signals having mutually different polarities.

In detail, the input terminal 110 includes first to eleventh transistors M1 to M11. The first transistor M1 has one terminal connected to a power source voltage VDD and a gate to which a first bias voltage biasp is applied, the second transistor M2 has one terminal connected to a first node A and a gate to which a first differential signal is applied, the third transistor M3 has one terminal connected to the other terminal of the first transistor M1 and a gate to which the first differential signal is applied, the fourth transistor M4 has one terminal connected to the other terminal of the first transistor M1 and a gate to which the first differential signal is applied, the fifth transistor M5 has one terminal connected to a second node B and a gate to which the first differential signal is applied, the sixth and seventh transistors M6 and M7 each have one terminal connected to the other terminals of the second and fifth transistors M2 and M5, a gate to which a second bias voltage biasn is commonly applied, and the other terminal connected to a ground voltage GND, the eighth transistor M8 has one terminal connected to the second node B and the other terminal connected to the ground voltage GND, the ninth transistor M9 has one terminal commonly connected to a gate thereof, the other terminal of the third transistor M3, and a gate of the eighth transistor M8, and the other terminal connected to the ground voltage GND, the tenth transistor M10 has one terminal commonly connected to a gate thereof and the other terminal of the fourth transistor M4, and the other terminal connected to the ground voltage GND, and the eleventh transistor Mil has one terminal connected to the first node A, a gate connected to the gate of the tenth transistor M10, and the other terminal connected to the ground voltage GND.

Here, the first and second nodes A and B are connected from the input terminal 110 to the output terminal 150. Negative feedback acts on the first and second nodes A and B in L1 and L2 directions, whereby they are not affected by a change in power and noise in transferring a signal.

The negative feedback unit 130 negatively feeds back the first and second data signals Vp and Vm input to the input terminal 110 to generate first and second feedback signals Vop and Vom. The negative feedback unit 130 may include a first negative feedback unit 131 negatively feeding back the first data signal Vp to generate and output the first feedback signal Vop and a second negative feedback unit 133 negatively feeding back the second data signal Vm to generate and output the second feedback signal Vom.

Here, the negative feedback refers to making an antiphase with respect to a first input signal when a portion of an output is fed back to the input, which serves to improve distortion or noise to stabilize an output signal. Also, a gain limitation or frequency characteristics may be arbitrarily set by changing the characteristics of a feedback signal along with the improvement of distortion or noise, and an amplifier can improve the frequency characteristics, amplitude characteristics, and phase characteristics.

Here, the negative feedback unit 130 performing negative feedback has a regulated cascode structure, stabilizing a signal in a current feedback manner, thus rendering the signal resistant to noise.

Also, the first negative feedback unit 131 may Include a twelfth transistor M12 in which a first current flows from one terminal to the other terminal according to the first data signal, a thirteenth transistor M13 mirroring the current flowing through the twelfth transistor M12, and a fourteenth transistor M14 connected in series to the thirteenth transistor M13. The second negative feedback unit 133 may include a fifteenth transistor MIS in which a second current flows from one terminal to the other terminal according to the second data signal, a sixteenth transistor M16 mirroring the current flowing through the fifteenth transistor M15, and a seventeenth transistor M17 connected in series to the sixteenth transistor M16.

In detail, the twelfth transistor M12 has one terminal connected to the power source voltage VDD and the other terminal connected to the first node A, the thirteenth transistor M13 has one terminal connected to the power source voltage VDD and the other terminal commonly connected to a gate thereof and a gate of the twelfth transistor M12, and the fourteenth transistor M14 has one terminal connected to the other terminal of the thirteenth transistor M13, a gate connected to the other terminal of the twelfth transistor M12, and the other terminal connected to one terminal of the seventh transistor M7. Also, the fifteenth transistor MIS has one terminal connected to the power source voltage VDD and the other terminal connected to the second node B, the sixteenth transistor M16 has one terminal connected to the power source voltage VDD and the other terminal commonly connected to a gate thereof and a gate of the fifteenth transistor M15, and the seventeenth transistor M17 has one terminal connected to the other terminal of the sixteenth transistor M16, a gate connected to one terminal of the eighth transistor M8, and the other terminal connected to one terminal of the seventh transistor M7.

Since the negative feedback unit 130, including the twelfth to seventeenth transistors M12 to M17, performs negative feedback, it can increase output impedance of the first and second data signals.

Namely, since the negative feedback unit 130 is configured as a regulated cascode in which the transistors are additionally provided to the current mirror structure, the output impedance as the amplitude of the voltage over the current of the first and second data signals can be increased, and since the increase in the output impedance increases the current flowing through the twelfth transistor M12 and the fifth transistor M15, obtaining the effect that the relatively low gain compared with the related art structure increases the bandwidth. In this manner, the low gain can be compensated for by increasing the gain of the output terminal.

Also, the increase in the output impedance leads to the excellence of the characteristics in a saturation region, stabilizing the characteristics of the output voltage over the change in voltage.

In addition, when the output Impedance is increased, channel length modulation is reduced, enhancing jitter characteristics.

The output terminal 150 outputs logic level signals by using the first and second feedback signals generated by the negative feedback unit 130. Namely, the output terminal 150 may convert the first and second feedback signals into digital signals having a high and low level, respectively, and output the converted digital signals.

The output terminal 150 has a small gain in comparison to the existing three-terminal structure, so it converts the first and second feedback signals into the logical level signals by using a push-pull amplifier.

As for the internal circuit diagram of the output terminal illustrated in FIG. 4, the output terminal 150 may include eighteenth transistor to twenty-fourth transistor M18 to M24. The eighteenth transistor M18 has one terminal connected to the power source voltage VDD and a gate to which the first bias voltage biasp is applied. The nineteenth transistor M19 has one terminal connected to the other terminal of the eighteenth transistor M18 and a gate connected to one terminal of the eleventh transistor M11. The twentieth transistor M20 has one terminal connected to the other terminal of the eighteenth transistor M18 and a gate connected to the gate of the seventeenth transistor M17. The twenty-first transistor M21 has one terminal commonly connected to a gate thereof and the other terminal connected to the ground voltage GND. The twenty-second transistor M22 has one terminal connected the other terminal of the twentieth transistor M20, a gate commonly connected to the twenty-first transistor M21, and the other terminal connected to the ground voltage GND. The twenty-third transistor M23 has one terminal connected to the power source voltage VDD and a gate connected to a common contact of the other terminal of the twentieth transistor M20 and one terminal of the twenty-second transistor M22, The twenty-fourth transistor M24 has one terminal connected to the other terminal of the twenty-third transistor M23, a gate commonly connected to the gate of the twenty-third transistor M23, and the other terminal connected to the ground voltage GND.

Namely, the output terminal 150 may calculate the signals respectively applied to the other terminal of the twenty-third transistor M23 and one terminal of the twenty-fourth transistor M24 to output a logic level signal from a common contact of the other terminal of the twenty-third transistor M23 and one terminal of the twenty-fourth transistor M24.

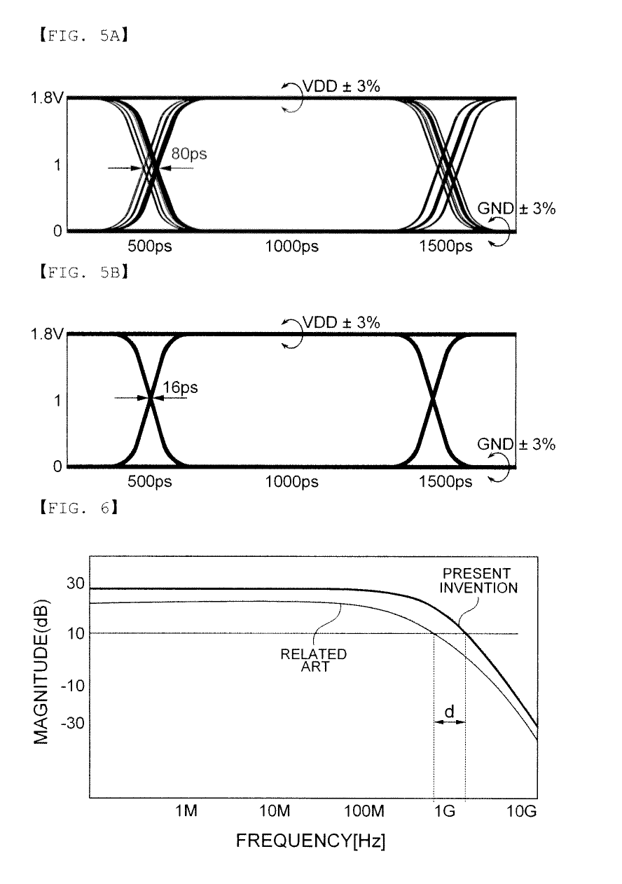

FIG. 5A is a graph showing a data eye structure and jitter characteristics according to the related art when noise is applied to the power source voltage and the ground voltage, and FIG. 5B is a graph showing a data eye structure and jitter characteristics according to an exemplary embodiment of the present invention when noise is applied to the power source voltage and the ground voltage.

Specifically, FIGS. 5A and 5B are graphs showing how the jitter characteristics are affected by using the data eye structure when noise of about 3% is applied to the power source voltage and the ground voltage, and in this case, when the width of the data eye is increased, a timing margin is enhanced to transfer a stable signal.

In FIG. 5A, it is noted that voltages are drastically changed due to noise, reducing the width of the data eye, which degrades the jitter characteristics. In comparison, in FIG. 5B, it is noted that since the power source voltage and the ground voltage are not affected by noise through negative feedback, voltages do not change, the width of the data eye increases, and thus, the jitter characteristics are enhanced to obtain a timing margin.

FIG. 6 is a graph showing a comparison between an operational bandwidth of the interface receiver according to an exemplary embodiment of the present invention and that of the related art.

With reference to FIG. 6, it is noted that when the interface receiver according to an exemplary embodiment of the present invention and the interface receiver according to the related art have the same amplitude (voltage, power), an operational bandwidth of the interface receiver according to an exemplary embodiment of the present invention is greater by d than that of the related art. Thus, since the interface receiver according to an exemplary embodiment of the present invention has a larger bandwidth than that of the related art, it can process signal more quickly.

In conclusion, in the interface receiver according to an exemplary embodiment of the present invention, the influence of parasitic capacitance can be reduced and the operational bandwidth can be increased by using the two-terminal structure, and the timing margin can be secured by improving the jitter characteristics by applying the negative feedback.

According to the exemplary embodiments of the present invention, an operational bandwidth can be increased by using a two-terminal structure instead of the three-terminal structure used in the related art.

Also, since the negative feedback unit is employed to have resistance to noise, jitter characteristics are improved (namely, jitter characteristics are not affected by noise) to thus secure a timing margin.

In addition, since the negative feedback unit is implemented to have a regulated cascode structure, output resistance is increased to have excellent characteristics in a saturation region, and thus, the characteristics of an output voltage over a change in voltage can be

Moreover, since a change of the current with respect to an input voltage is small after the saturation region, a voltage can be stably output even though the current is changed by power noise.

Furthermore, since the two-terminal structure is employed, the size can be reduced and the receiver can be driven with low power only.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An interface receiver comprising:
an input terminal receiving first and second data signals;
a negative feedback unit negatively feeding back the first and second data signals input to the input terminal to generate first and second feedback signals; and
an output terminal outputting logic level signals by using the first and second feedback signals generated by the negative feedback unit.

2. The interface receiver according to claim 1, wherein the negative feedback unit has a regulated cascode structure.

3. The interface receiver according to claim 1, wherein the first and second data signals include first and second differential signals having mutually opposite polarities.

4. The interface receiver according to claim 1, wherein the input terminal has a rail-to-rail structure.

5. The interface receiver according to claim 3, wherein the input terminal includes:
a first transistor M1 having one terminal connected to a power source voltage and a gate to which a first bias voltage biasp is applied;
a second transistor M2 having one terminal connected to a first node A and a gate to which a first differential signal is applied;
a third transistor M3 having one terminal connected to the other terminal of the first transistor M1 and a gate to which the first differential signal is applied;
a fourth transistor M4 having one terminal connected to the other terminal of the first transistor M1 and a gate to which the first differential signal is applied;
a fifth transistor M5 having one terminal connected to a second node B and a gate to which the first differential signal is applied;
sixth and seventh transistors M6 and M7 each having one terminal connected to the other terminals of the second and fifth transistors M2 and M5, a gate to which a second bias voltage biasn is commonly applied, and the other terminal connected to a ground voltage;
an eighth transistor M8 having one terminal connected to the second node B and the other terminal connected to the ground voltage;
an ninth transistor M9 having one terminal commonly connected to the gate of the eighth transistor M8, and the other terminal connected to the ground voltage;
a tenth transistor M10 having one terminal commonly connected to a gate thereof and the other terminal of the fourth transistor M4, and the other terminal connected to the ground voltage; and
an eleventh transistor Mil having one terminal connected to the first node A, a gate connected to the gate of the tenth transistor M10, and the other terminal connected to the ground voltage.

6. The interface receiver according to claim 5, wherein the negative feedback unit includes:
a first negative feedback unit negatively feeding back the first data signal to generate the first feedback signal, and outputting the first feedback signal; and
a second negative feedback unit negatively feeding back the second data signal to generate the second feedback signal, and outputting the second feedback signal.

7. The interface receiver according to claim 6, wherein the first negative feedback unit includes:
a twelfth transistor M12 having one terminal connected to the power source voltage and the other terminal connected to the first node A;
a thirteenth transistor M13 having one terminal connected to the power source voltage and the other terminal commonly connected to a gate thereof and a gate of the twelfth transistor M12; and
a fourteenth transistor M14 having one terminal connected to the other terminal of the thirteenth transistor M13, a gate connected to the other terminal of the twelfth transistor M12, and the other terminal connected to one terminal of the seventh transistor M7.

8. The interface receiver according to claim 7, wherein the second negative feedback unit includes:
a fifteenth transistor M15 having one terminal connected to the power source voltage and the other terminal connected to the second node B;
a sixteenth transistor M16 having one terminal connected to the power source voltage and the other terminal commonly connected to a gate thereof and a gate of the fifteenth transistor M15; and
a seventeenth transistor M17 having one terminal connected to the other terminal of the sixteenth transistor M16, a gate connected to one terminal of the eighth transistor M8, and the other terminal connected to one terminal of the seventh transistor M7.

9. The interface receiver according to claim 8, wherein the output terminal includes:
an eighteenth transistor M18 having one terminal connected to the power source voltage and a gate to which the first bias voltage to one terminal of the eleventh transistor M11;
a nineteenth transistor M19 having one terminal connected to the other terminal of the eighteenth transistor M18 and a gate connected to one terminal of the eleventh transistor M11;
a twentieth transistor M20 having one terminal connected to the other terminal of the eighteenth transistor M18 and a gate connected to the gate of the seventeenth transistor M17;
a twenty-first transistor M21 having one terminal commonly connected to a gate thereof and the other terminal connected to the ground voltage;
a twenty-second transistor M22 having one terminal connected the other terminal of the twentieth transistor M20, a gate commonly connected to the twenty-first transistor M21, and the other terminal connected to the ground voltage;
a twenty-third transistor M23 having one terminal connected to the power source voltage and a gate connected to a common contact of the other terminal of the twentieth transistor M20 and one terminal of the twenty-second transistor M22; and
a twenty-fourth transistor M24 having one terminal connected to the other terminal of the twenty-third transistor M23, a gate commonly connected to the gate of the twenty-third transistor M23, and the other terminal connected to the ground voltage.

10. The interface receiver according to claim 9, wherein the output terminal outputs the logic level signals from a common contact of the other terminal of the twenty-third transistor and one terminal of the twenty-fourth transistor.

11. An interface receiver comprising:
an input terminal receiving first and second data signals;
a first negative feedback unit including a twelfth transistor M12 in which a first current flows according to the first data signal, a thirteenth transistor mirroring the current flowing through the twelfth transistor M12, and a fourteenth transistor M14 connected in series to the thirteenth transistor M13, and negatively feeding back the first data signal to generate a first feedback signal;
a second negative feedback unit including a fifteenth transistor M15 in which a second current flows according to the second data signal, a sixteenth transistor M16 mirroring the current flowing through the fifteenth transistor M15, and a seventeenth transistor M17 connected in series to the sixteenth transistor M16, and negatively feeding back the second data signal to generate a second feedback signal; and
an output terminal outputting logic level signals by using the first and second feedback signals generated by the first and second negative feedback units, respectively.

12. The interface receiver according to claim 11, wherein the input terminal includes:
a first transistor M1 having one terminal connected to a power source voltage and a gate to which a first bias voltage biasp is applied;
a second transistor M2 having one terminal connected to a first node A and a gate to which a first data signal is applied;
a third transistor M3 having one terminal connected to the other terminal of the first transistor M1 and a gate to which the first differential signal is applied;
a fourth transistor M4 having one terminal connected to the other terminal of the first transistor M1 and a gate to which the first differential signal is applied;
a fifth transistor M5 having one terminal connected to a second node B and a gate to which the first data signal is applied;
sixth and seventh transistors M6 and M7 each having one terminal connected to the other terminals of the second and fifth transistors M2 and M5, a gate to which a second bias voltage biasn is commonly applied, and the other terminal connected to a ground voltage;
an eighth transistor M8 having one terminal connected to the second node B and the other terminal connected to the ground voltage;
a ninth transistor M9 having one terminal commonly connected to a gate thereof, the other terminal of the third transistor M3, and a gate of the eighth transistor M8, and the other terminal connected to the ground voltage;
a tenth transistor M10 having one terminal commonly connected to a gate thereof and the other terminal of the fourth transistor M4, and the other terminal connected to the ground voltage; and
an eleventh transistor M11 having one terminal connected to the first node A, a gate connected to the gate of the tenth transistor M10, and the other terminal connected to the ground voltage.

13. The interface receiver according to claim 12, wherein the twelfth transistor Mid has one terminal connected to the power source voltage and the other terminal connected to the first node A, the thirteenth transistor M13 has one terminal connected to the power source voltage and the other terminal commonly connected to a gate thereof and a gate of the twelfth transistor M12; and the fourteenth transistor M14 has one terminal connected to the other terminal of the thirteenth transistor M13, a gate connected to the other terminal of the twelfth transistor M12, and the other terminal connected to one terminal of the seventh transistor M7.

14. The interface receiver according to claim 13, wherein the fifteenth transistor M15 has one terminal connected to the power source voltage and the other terminal connected to the second node B, the sixteenth transistor M16 has one terminal connected to the power source voltage and the other terminal commonly connected to a gate thereof and a gate of the fifteenth transistor M15, and the seventeenth transistor M17 has one terminal connected to the other terminal of the sixteenth transistor M16, a gate connected to one terminal of the eighth transistor M8, and the other terminal connected to one terminal of the seventh transistor M7.

15. The interface receiver according to claim 14, wherein the output terminal includes:
an eighteenth transistor M18 having one terminal connected to the power source voltage and a gate to which the first bias voltage biasp is applied;
a nineteenth transistor M19 having one terminal connected to the other terminal of the eighteenth transistor M18 and a gate connected to one terminal of the eleventh transistor M11;
a twentieth transistor M20 having one terminal connected to the other terminal of the eighteenth transistor M18 and a gate connected to the gate of the seventeenth transistor M17;
a twenty-first transistor M21 having one terminal commonly connected to a gate thereof and the other terminal connected to the ground voltage;
a twenty-second transistor M22 having one terminal connected the other terminal of the twentieth transistor M20, a gate commonly connected to the twenty-first transistor M21, and the other terminal connected to the ground voltage;
a twenty-third transistor M23 having one terminal connected to the power source voltage and a gate connected to a common contact of the other terminal of the twentieth transistor M20 and one terminal of the twenty-second transistor M22; and
a twenty-fourth transistor M24 having one terminal connected to the other terminal of the twenty-third transistor M23, a gate commonly connected to the gate of the twenty-third transistor M23, and the other terminal connected to the ground voltage.
